(19) United States
(12) Patent Application Publication
(10) Pub. No.: US 2007/0245306 A1
(43) Pub. Date: Oct. 18, 2007

(54) User Interface Image Element Display and Adaptation System

(75) Inventors: Laurie Dameshek, Newtown Square, PA (US); Aaron Emerson Martlage, Philadelphia, PA (US); Claus Knapheide, Philadelphia, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS USA, INC., MALVERN, PA (US)

(21) Appl. No.: 11/668,513

(22) Filed: Jan. 30, 2007

Related U.S. Application Data
(60) Provisional application No. 60/774,153, filed on Feb. 16, 2006.

(51) Int. Cl. G06F 9/44

(52) U.S. Cl. 717/113; 717/114; 717/109

(57) ABSTRACT

A system provides a single-click expandable data control implemented in a user interface development language as a data entry and viewing element including options enabling or restricting data entry and specifying a related dialog for entry or selection of data for a primary display field. A system provides a single-click expandable data element in HTML, for example, as a data entry and viewing element that is used within a user interface interactive page to allow a single line-height data display using a single mouse click to expand or collapse data, thereby providing a simple means for a user to view or enter larger amounts of data than typically fit within the limited screen space. A user interface system adaptively presents information to a user. The system includes a display processor for initiating generation of data representing an image. The image includes, an image element box comprising a text data presentation row automatically expandable into multiple text data presentation rows in response to user selection of the image element box. An executable procedure associated with the image element box determines whether text in the multiple text data presentation rows is at least one of, (a) delete only, (b) read-only and (c) readable and writable. The executable procedure is in a user interface compatible code language (e.g., HTML, SGML, XML, Visual Basic) and execution of the executable procedure is initiated in response to user selection of the image element box.

This is a non-provisional application of provisional application Ser. No. 60/774,153 by Laurie Dameshek et al. filed Feb. 16, 2006.

### FIELD OF THE INVENTION

This invention concerns a user interface system for adaptively presenting information using an expandable or collapsible data entry and viewing image element enabling a user to view or enter variable amounts of data.

### BACKGROUND OF THE INVENTION

Known user interface systems typically employ cumbersome methods to open multiple image windows or dialogs in order to expand displayed information. Other known systems provide multiple data rows of information that are not collapsible to a single primary row and require substantial onerous on screen scrolling by a user to find information because of a lack of a concurrent view of primary or related information. The relative immaturity of HTML and web browser user interface technology means there are many limitations to known methods of displaying data that have not been addressed as yet. Known systems that rely on opening multiple windows to show information take time to display and open such windows in conjunction with other displayed data. These systems may involve hiding a primary image screen from user view and potentially introduce data synchronization problems, particularly if a system allows image dialogs to be treated separately. While these approaches are workable in some situations, in other situations where there is a need to view extended (additional) data adjacent to current displayed data, a window moving and management problem is created resulting in loss of valuable context data to a user.

Known systems apply multiple different methods in displaying data without consistency and without providing memory reinforcement to a user. Further, because user interface experience varies greatly with different applications and in different environments, there is a need to provide user interface consistency to improve efficiency and comfort for a user. A system according to invention principles addresses these deficiencies, needs and related problems.

### SUMMARY OF THE INVENTION

A system provides a single-click expandable data element implemented in a computer user interface, as a data entry and viewing element that is used within an interactive page to allow a single line-height data display. The display is expanded over other elements on the screen or collapsed back to its original state in response to a single mouse click, thereby providing a simple means for a user to view or enter larger amounts of data than typically fit within the limited screen space. A user interface system adaptively presents information to a user. The system includes a display processor for initiating generation of data representing an image. The image includes, an image element box comprising a text data presentation row automatically expandable into multiple text data presentation rows in response to user selection of the image element box. An executable procedure associated with the image element box determines whether text in the multiple text data presentation rows is at least one of, (a) delete only, (b) read-only and (c) readable and writable. The executable procedure is in a code language (e.g., HTML, SGML, XML, Visual Basic) compatible with Internet Browser or non-internet Browser applications and execution of the executable procedure is initiated in response to user selection of the image element box.

### BRIEF DESCRIPTION OF THE DRAWING

FIG. 1 shows a Hospital Information System (HIS) including a user interface system for adaptively presenting information to a user, according to invention principles.

FIG. 2 shows a user interface display image including a variety of implementations of an automatically expandable image element box, according to invention principles.

FIG. 3 shows a user interface display image illustrating a particular expandable image element box, according to invention principles.

FIG. 4 shows a user interface display image illustrating an expandable image element box including data, according to invention principles.

FIG. 5 shows a user interface display image illustrating an expandable image element box including data provided by interaction with a separate dialog, according to invention principles.

FIG. 6 shows a user interface display image illustrating a disabled expandable image element box responsive to a workflow, according to invention principles.

FIG. 7 shows a user interface display image illustrating a disabled expandable image element box populated by dialog interaction, according to invention principles.

FIG. 8 shows a flowchart of a process performed by a user interface system for adaptively presenting information to a user, according to invention principles.

### DETAILED DESCRIPTION OF THE INVENTION

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of a controller or microprocessor, for example. The processor may operate with a display processor or generator. A display processor or generator is a known element for generating signals representing display images or portions thereof. A processor and a display processor comprises any combination oft hardware, firmware, and/or software.

An executable application, as used herein, comprises code or machine readable instructions for conditioning the processor to implement predetermined functions, such as those of an operating system, a context acquisition system or other information processing system, for example, in response to user command or input.

An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A user interface (UT), as used herein, comprises one or more display images, generated by the display processor under the control of the processor enabling user interaction with a processor or other device and associated data acquisition and processing functions. The Ul also includes an executable procedure or executable application. The executable procedure or executable application conditions the display processor to generate signals representing the UT display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of the executable procedure or executable application manipulates the UT display images in response to the signals received from the input devices. In this way, the user interacts with the display image using the input devices, enabling user interaction with the processor or other device. A workflow processor initiates and manages a sequence of tasks for performance by a worker, device or both. The workflow processor provides data representing a task list of one or more workers and updates and manages the task list. The functions and process steps herein may be performed automatically or wholly or partially in response to user command. A dialog comprises a menu or image area overlay supporting user interaction. An overlay dialog or menu is superimposed over other display elements that may or may not be removed. An activity performed automatically is performed in response to executable instruction or device operation without user direct initiation of the activity.

A system according to invention principles provides a method for an application with an interactive user interface to provide a user the ability to access and view data that occupies more space than a single-line display on a data entry form and determines whether a user is able to view, update or delete the data. The system is configurable via user interface selectable options, to determine whether data can be directly entered in a displayed image element box or the box is populated by selection from a related form. The image element box is expandable and collapsible and may be employed with a search screen or catalog browser or in a detailed image screen, for example, where complex data fields are processed and collapsed into a single row display on a form. The image element box display also provides a clear visual indication to the user that more information is present and may be viewed in response to expanding a collapsed box.

The system addresses the problem of displaying complex data within a computer user interface in limited image space. The systemp provides a single-click expandable data element implemented in code as a data entry and viewing element that is used within an interactive user interface page to allow a single line-height data display using a single mouse click to expand over the static information below and to collapse the element to its original state. Thereby the system enables a user to view or enter larger amounts of data than typically fit within the limited screen space. The expandable data element and its functional options provide features including an expandable and collapsible displayed image element, an ability to limit data entry, e.g., to data derived in response to a search and determination of a related dialog or a complex related-data form for data entry, selection and edit of data for input into the expandable data element. The advantage for users of the software is that a user gets access to much more information than fits on a screen at one time, and can maintain a stable memory of the information and image regardless of whether the detail entry is expanded or collapsed If there is no information to display, the user is not burdened with an open empty area that wastes space on screen. The image element holds expandable information avoiding the need for related detail forms to be invoked, which takes time for information download and removes the stability afforded by use of a single screen.

The expandable data element provides flexibility within a software application to support providing consistent, user interface image displays. The expandable data element displays data in a limited space together with user cues that there is more information to view or more data to enter. The expandable data element defined as a single reusable feature reduces a need for code to implement an image element box for a single particular use and advantageously provides a re-usable set of code that is readily modified for a particular user interface.

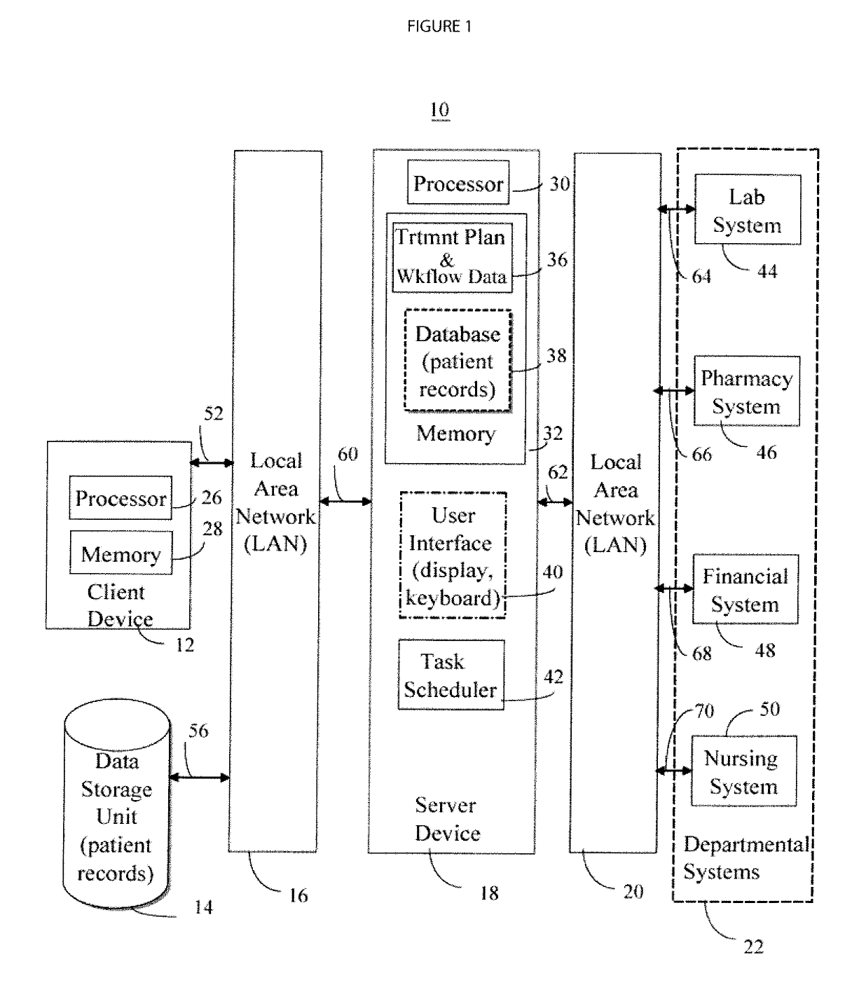

FIG. 1 shows a Hospital information System (HIS) including user interface system 40 for adaptively presenting information to a user. Healthcare information system 10 includes a client device 12, a data storage unit 14, a first local area network (LAN) 16, a server device 18, a second local area network (LAN) 20, and departmental systems 22. The client device 12 includes processor 26 and memory unit 28 and may comprise a personal computer, for example. The healthcare information system 10 is used by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. Examples of the people being serviced by the healthcare provider include, without limitation, a patient, a resident, and a client.

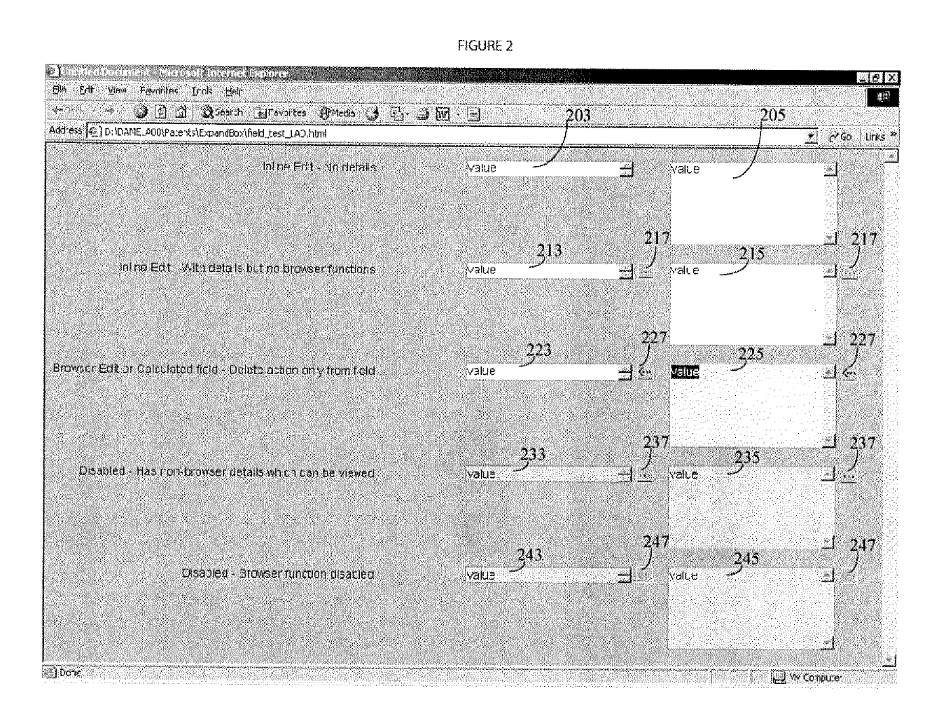

User interface system 40 in server 18 provides the image displays including expandable image element boxes of FIGS. 2-7. An expandable image element box is a single text box that displays as a single row of text but may contain more information that displays in an expanded, multi-line view of the text box if the user clicks on the image element box. In addition, User interface 40 presents an expandable image element box together with a button that allows the user to launch a dialog that either allows viewing or entry of data in related fields, or that provides a method to select or calculate the value that displays in the expandable field. The options for setup of this expandable image element box are accessible and enable a user to incorporate a customized expandable image element box into a data entry or display form. This capability enables use of a single common expandable image element box that may be tailored to a particular workflow (a user and/or device performed task sequence) and advantageously eliminates a need to support a multiplicity of different types of expandable image element box.

Server device 1I permits multiple users to access user interface images including expandable image element boxes for adaptively presenting information to a user at multiple client devices as needed by the user to view or edit data. User interface 40 includes a display processor for initiating generation of data representing an image including an image element box comprising a text data presentation row automatically expandable into multiple text data presentation rows in response to user selection of the image element box. An executable procedure associated with the image element box determines whether text in the multiple text data presentation rows is delete only, read-only or readable and writable. The executable procedure employs an Internet Browser compatible code language in one embodiment (e.g., HTML, XML, SGML, Visual Basic) and execution of the executable procedure is initiated in response to user selection of the image element box. In another embodiment user interface system 40 is located in client device 12.

User interface system 40 includes an input device that permits a user to provide information to client device 12 and an output device that provides a user a display of user interface images including expandable image element boxes for adaptively presenting information. Typically the input device is a keyboard and mouse, but also may be a touch screen or a microphone with a voice recognition program, for example. The output device provides information to the user responsive to the input device receiving information from the user or responsive to other activity by client device 12. For example, the display presents information responsive to the user entering information in the client device 12 via a keyboard.

FIG. 2 shows a user interface display image including a variety of implementations of an automatically expandable image element box. A user is able to select and set characteristics of an expandable image element box in a form design process. The user selectable characteristics include a Tool Tip option whereby the same value displays whether the field is expanded or collapsed and the character display length of the displayed field when collapsed as well as the number of rows to display when expanded. Alternatively, a user may allow a dynamic display length of the displayed field. Other user selectable characteristics include an initial state (data field value) when an expandable image element box is loaded in expanded or collapsed mode. A user is also able to configure an expandable image element box to support any form of data entry and type of data edit within a field, or to alternatively require a related dialog enabling a user to determine a value for the element box. A user is able to allow data field value deletion within an expandable image element box and determine a consistent visual style representation for data in data fields. A user is also able to configure a data field for inline or related dialog edit and ensure that visual style representation for enabled or disabled fields matches the style for other enabled or disabled fields. A user is also able to associate a data field in an expandable image element box with a Related Dialog, e.g., a web browser dialog for displaying externally sourced but related data or a calculation dialog for performing a calculation providing a result shown in the image element box.

Expanded image element box 205 (FIG. 2) illustrates the expanded form of collapsed image element box 203 comprising a data field for containing editable data. Box 205 displays as expanded in response to user selection (e.g., by mouse clicking) of box 203 and comprises a multiple line scrollable data field. Similarly, expanded image element box 215 illustrates the expanded form of collapsed image element box 213 but with the addition of a clickable screen element 217. Icon 217 indicates additional data is available to add or edit for box 213 or 215, but is accessible only when box 213 is in collapsed mode. Expanded image element box 225 illustrates the expanded form of collapsed image element box 223 but with a shaded (or highlighted e.g., colored) background that indicates the data in the expanded element box may be deleted, but not edited in place in any other way. Icon 227 indicates additional data is available to add to expanded box 225 or image element box 223 in collapsed mode. Specifically the additional data available in box 223 or 225 (as indicated by particular icon 227) may be updated by clicking the screen element 227 to display a dialog where the user then searches for data or calculates a value to place in box 223.

Similarly, the gray shaded expanded image element box 235 illustrates the expanded form of collapsed image element box 233 and provides for additional data entry as indicated by icon 237. However, the gray shade indicates editing or other active functions of boxes 233 and 235 are disabled. Also the gray shaded expanded image element box 245 illustrates the expanded form of collapsed image element box 243 and indicates that a related dialog is used to derive data via search or calculation, for example, as indicated by icon 247. However, the gray shade indicates user interface compatible functions associated with the additional data available in box 245 are disabled.

Display images provided by user interface 40 are implemented using HTML code, for example, and support data entry functions enabling users to access larger arnounts of data than can fit on a display image in a static condition. The user interface code enables a user to configure an expandable image element box via simple parameters or code settings. The expandable image element box is placed on a user interface application page in a similar manner as any other display image element. In response to display of an image including an expandable image element box and execution of associated code and upon a user clicking the expandable image element box, the sin-le line text box expands in place, overlay the fields that exist on the static screen. User selected options determine whether this single line text box allows inline data entry, inline deletion, or edits via another data entry form, such as a search or calculation dialog. If another form is used to place data in an expandable image element box, a user is able to specify a method used to launch that form and also to name the form. An expandable image element box has associated settings and syntax enabling a user (or programmer) to individually set parameters which may be interpreted by a user interface display processor to set display characteristics and type of interaction.

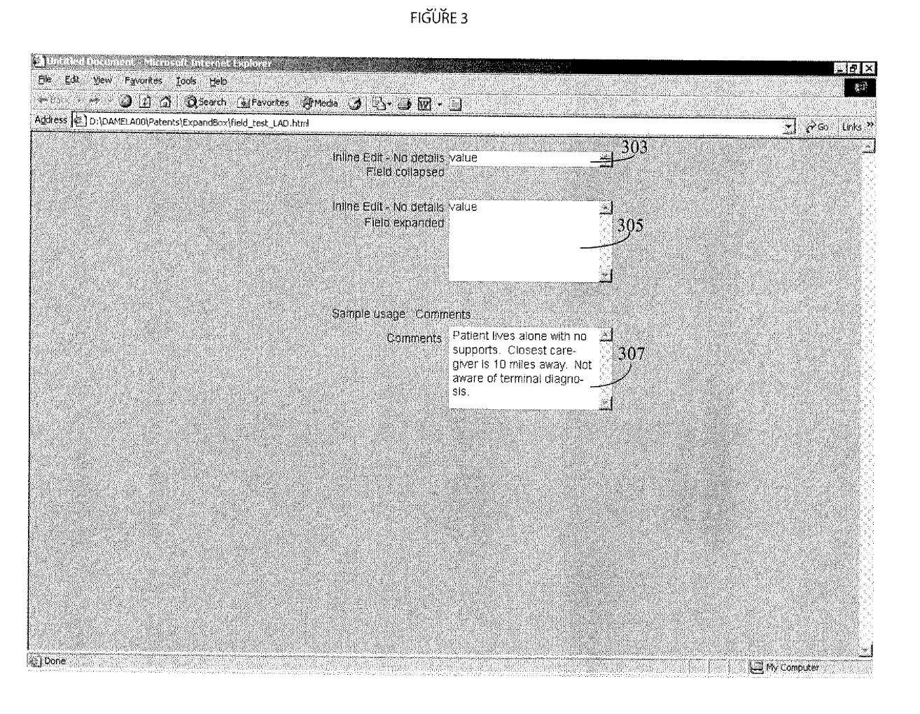

FIG. 3 shows a user interface display image illustrating a particular expandable image element box. Expanded image element box 305 illustrates the expanded formn of collapsed image element box 303 comprising a data field for containing inline editable data. In this illustration box 305 contains no further information than is in box 303. Expanded image element box 307 exemplifies additional information that may be contained in expanded image element box 305 (specifically patient related comments). Box 303 may be expanded by placing the cursor inside the image element area, and box 305 may be collapsed by placing the cursor outside the image element area, anywhere else on the screen. Further, a mouser over or tooltip function for a collapsed image element box shows the contents of the expanded box in the tooltip when the mouse cursor is over the box. The box itself does not open, but the tooltip behaves as any normal tooltip, presenting data contents.

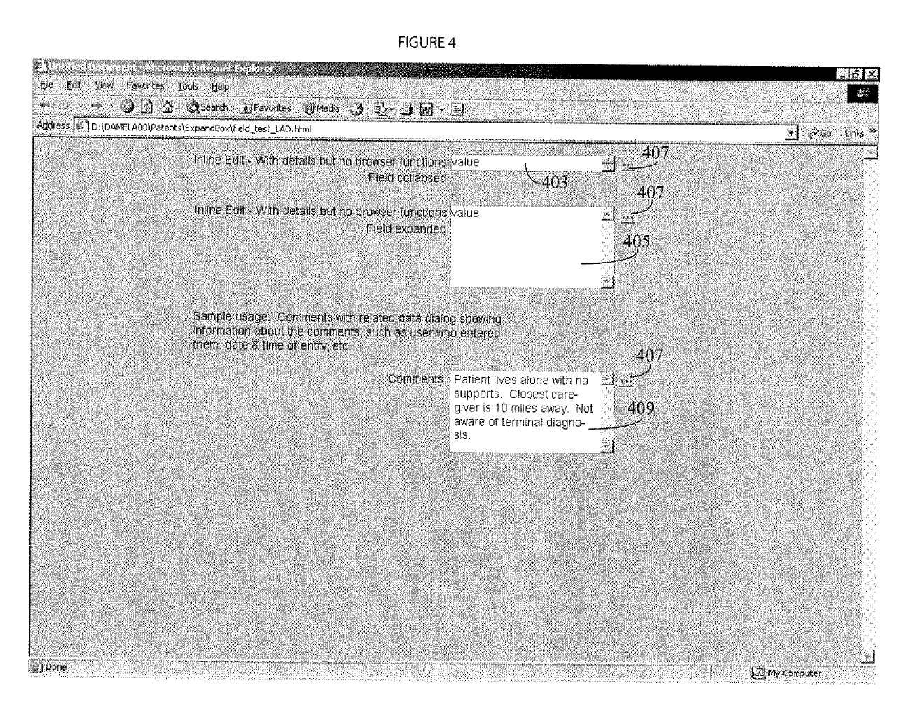

FIG. 4 shows a user interface display image illustrating an expandable image element box associated with a related data dialog. Expanded image element box 405 illustrates the expanded form of collapsed image element box 403. Clickable image element 407 indicates additional data is available related to expanded box 405 or image element box 403 in collapsed mode. Data in box 405 is inline editable and is the expanded version that displays in response to user selection (e.g., by mouse clicking) of box 403. Box 405 may be collapsed by placing the cursor outside the image element area on the screen. Expanded image element box 409 exemplifies additional information that may be contained in expanded image element box 405 (for example, comments). In addition upon user selection (e.g., by mouse clicking) of clickable image 407 a related data dialog is displayed (not shown to preserve drawing clarity) identifying additional information associated with the data in element 405. For example, the related dialog may show the user who entered the comments and a date and time of their entry.

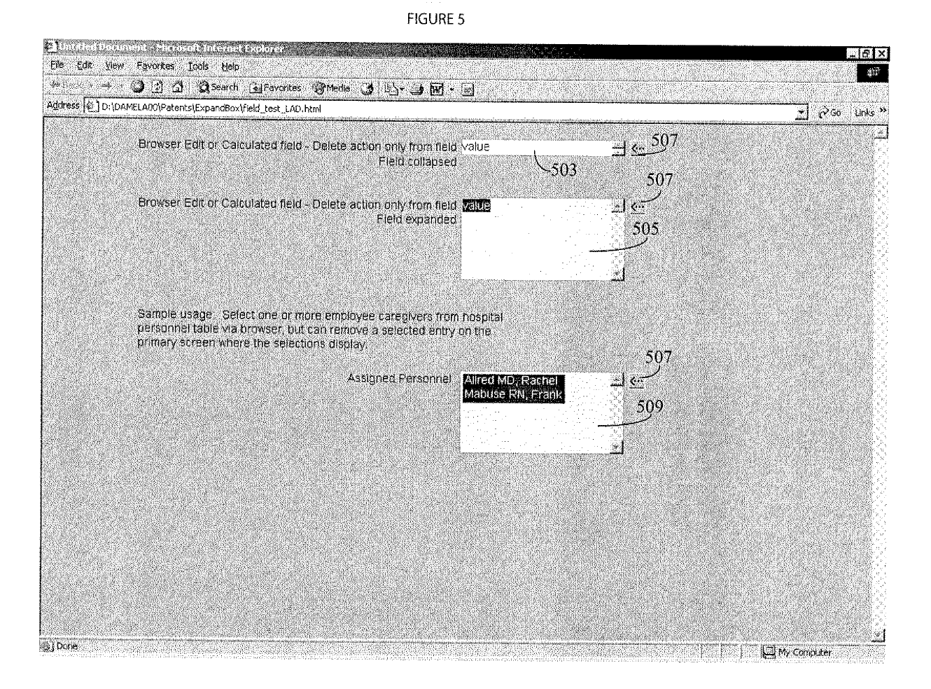

FIG. 5 shows a user interface display image illustrating an expandable image element box including data. Expanded image element box 505 illustrates the expanded form of collapsed image element box 503. Clickable image 507 indicates an additional dialog is used to derive or calculate data and is used to place data into expanded box 505 or image element box 503 in collapsed mode. Data may not be entered directly in box 503 and 505 in this embodiment but by data entry via the separate dialog (not shown to preserve drawing clarity) or in response to a performed calculation. Data may be deleted directly from box 505. In another embodiment the expanded image element box is configurable to have any of the characteristics mentioned herein and to enable data to be entered directly into box 505, for example. Expanded image element box 509 exemplifies additional information that may be contained in expanded image element box 505. Specifically, box 509 illustrates one or more employees may be selected fromt a personnel table via a search or browser dialog. In this example, a user is able to delete one or more selected employees directly using box 509.

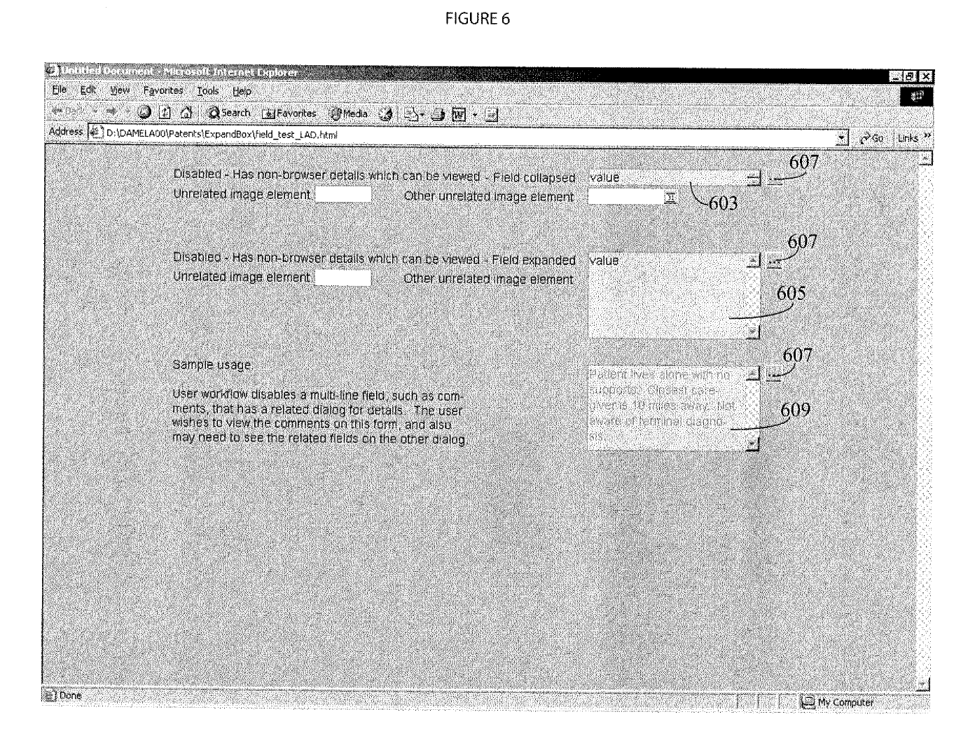

FIG. 6 shows a user interface display image illustrating a disabled expandable image element box. This box is disabled in response to execution of a task in a workfiow task sequence, for example. Disabled expanded image element box 605 illustrates the expanded form of disabled collapsed image element box 603. Clickable image element 607 indicates that there exists an additional dialog containing related data, along with image element box 603. The expandable image element box is configured so that execution of a task in a workflow task sequence involving device and worker actions disables a portion or the whole of, expanded image element box 605 as illustrated in box 609. The expanded box overlays unrelated image elements. Specifically box 609 (or box 605) illustrates a multi-line field that may include worker comments, for example, that has a related dialog (not shown) describing details connected with the comments (such as identifying who entered them, time and date of entry etc.). The user is able to view as read-only, the cornments and the related dialog in response to selection of box 609, for example, but is unable to edit or delete the comments or the data in the related dialog because the workflow has disabled these items.

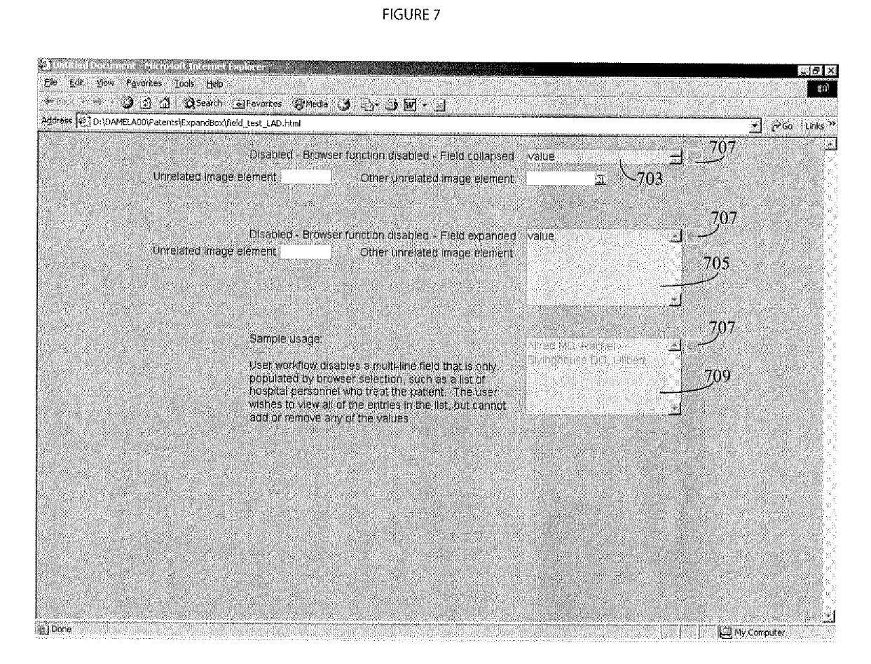

FIG. 7 shows a user interface display image illustrating a disabled expandable image element box populated by browser interaction and disabled in response to execution of a task in a workflow task sequence, for example. Disabled expanded image element box 705 illustrates the expanded form of disabled collapsed image element box 703 that is generated in response to user selection of box 703. Clickable image element 707 indicates that expanded box 705 or collapsed box 703 is normally populated via a related search dialog or using data derived by calculation. The expandable image element box is configured so that execution of a task in a workflow task sequence involving device and worker actions, for example, disables the expanded image element box 705 as illustrated in box 709. The expanded box overlays unrelated image elements. Gray shading of boxes 703, 705 and 709 indicates the data in these boxes is read-only and viewable but disabled from user alteration. Specifically, box 709 illustrates a multi-line field that is populated, e.g., with a list of personnel who can perform an action, by user selection via a search dialog. The user is able to view the selected personnel list but cannot edit or delete any data.

The use of the configurable expandable image element box reduces the time and burden involved in developing consistent display images with advanced data entry functions and increases consistency within executable applications and between different executable applications for a particular data entry function. The use of the configurable expandable image element box also increases usability for users who need to view a large amount of data and understand where information can be viewed and edited. The system reduces a need to launch additional screen display dialogs for viewing, editing and deletion of relatively large data fields and increases familiarity with a common image element box and its style and treatment.

Existing known user interface programming code languages support a drop-down image element box that can display multiple lines of text and is configurable to be enabled (user can open) or disabled (remains closed and displays the currently selected or default value). However, in the known drop-down image element box, disabled text is not available for selection and copying and a text area is not automatically expanded and collapsed merely by clicking to place the cursor inside the image element area. Further, the disabled text is limited to selection only, and is not configurable to allow deletion of an entire value without also enabling addition and modification of existing text.

An expandable image element box is usable to display relatively lengthy information in a small area and to collect and/or display a list or wrapped text configurable with options as to whether deletion is allowed or whether there is a related dialog to enter additional information or to select values for incorporation in the image element box. The expandable image element box, whether configured to be editable, delete-only, or display-only, may be automatically populated from user interaction with another data entry field or interactive control on the same form. A configurable option determines an expandable image element box that self-populates when a user enters that box, via tab key or mouse click into the box. The expandable image element box identifies and executes appropriate code to determine the correct field data based upon other context information, such as a user identifier, date or value of another data field or fields.

In one embodiment, when an expandable image element box is used with an additional button to launch another form for more information or for selection of a data field value, the form associated with the additional button may be linked directly to the expandable image element box. This enables automatic launching of another dialog for data entry, view or selection, thereby seamlessly allowing a user to quickly incorporate an expandable image element box and populate it or related fields in one step. Upon closing the other dialog, the expandable image element box may be pre-configured to be automatically updated.

Returning to FIG. 1, server device 18 generally includes processor 30, a memory unit 32 including workflow data and a treatment plan 36 and a database 38 containing patient records. Server device 18 also includes Rules Engine and Workflow Engine (task scheduler 42). Server device 18 is may be implemented as a personal computer or a workstation. Database 38 provides a location for storing patient records and data storage unit 14 provides an alternate store for patient records, as well as other information for hospital information system 10. The information in data storage unit 14 and database 38 is accessed by user interface 40 for presenting information using an expandable image element box. Alternatively, patient records may be accessed from memory unit 28 in client device 12, or in memory units in the departmental systems 22. Patient records in data storage unit 14 include information related to a patient including, without limitation, biographical, financial, clinical, workflow, care plan and patient encounter (visit) related information.

The communication paths 52, 56, 60, 62, 64, 66, 68 and 70 permit the various elements, shown in FIG. 1, to communicate with the first LAN 16 or the second LAN 20. Each of the communication paths 52, 56, 60, 62, 64, 66, 68 and 70 are preferably adapted to use one or more data formats, otherwise called protocols, depending on the type and/or configuration of the various elements in the healthcare information systems 10. Examples of the information system data formats include, without limitation, an RS232 protocol, an Ethernet protocol, a Medical Interface Bus MIB) compatible protocol, DICOM protocol, an Internet Protocol (I.P.) data format, a local area network (LAN) protocol, a wide area network (WAN) protocol, an IEEE bus compatible protocol, and a Health Level Seven (HL7) protocol.

Departmental systems 22 are systems that need access to information or provide information related to the health and/or welfare of patients in the care of the healthcare provider. Examples of the departmental systems 22 include, a lab system 44, a pharmacy system 46, a financial system 48 and a nursing system 50, as shown in FIG. 2, but may also include a records system, a radiology system, an accounting system, a billing system, and any other system required or desired in a healthcare information system.

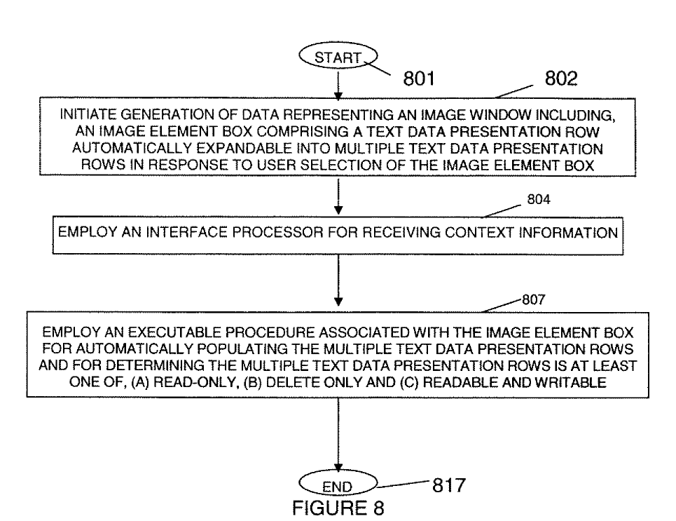

FIG. 8 shows a flowchart of a process performed by user interface 40 for adaptively presenting information to a user. In step 802 following the start at step 801 a display processor in unit 40 initiates generation of data representing an image (e.g., comprising an image window). The image includes an image element box enabling text data entry by a user and comprising a text data presentation row automatically expandable into multiple text data presentation rows in response to user selection of the image element box. The image includes a user selectable button associated with the multiple text data presentation rows for at least one of, (a) initiating generation of a dialog window presenting more information concerning the text in the multiple text data presentation rows, (b) selecting an item in the multiple text data presentation rows and (c) initiating a calculation used in providing data for display in the multiple text data presentation rows. The display processor also initiates generation of a display window presenting data representing content of the image element box upon detection of a mouse-over condition. An interface processor in user interface 40 in step 804 receives context information including at least one of, user identifier, a patient identifier, an application specific data object identifier and information associated with a data field in a form including the image element box.

In step 807 an executable procedure in user interface 40 associated with the image element box, automatically populates the multiple text data presentation rows and determines the multiple text data presentation rows are at least one of, (a) read-only, (b) delete-only and (c) readable and writable. The executable procedure is implemented in an Internet Browser compatible code language and execution of the executable procedure is initiated in response to user selection of said image element box. The Internet Browser compatible code language comprises, (a) HTML, (b) SGML, (c) XML, (d) Visual Basic, and derivatives thereof for example. In another embodiment non-Internet Browser compatible code may be used. The executable procedure associated with the image element box automatically populates the multiple text data presentation rows with at least one of data acquired from a separate dialog, data derived in response to a calculation and data associated with received context information. A configuration processor in unit 40 enables user configuration of the image element box and determination of a style of presentation of text and that the text data presentation rows are, read-only, readable and writable or delete only.

The display processor initiates generation of data representing an image including a browser dialog menu enabling user data entry within a web browser, e.g., of text associated with the text data presentation rows, The text in the dialog menu associated with the text data presentation rows indicates, an identifier of a user that entered text in the presentation rows and a time and date of entry of text in the presentation rows. A command processor in unit 40 initiates generation of data representing an update of the image including an expanded image element box. The command processor initiates execution of the executable procedure associated with the image element box to determine whether text in the multiple text data presentation rows is, delete only, read-only or readable and writable in the expanded image element box, in response to user selection of the image element box. The process of FIG. 8 terminates at step 817.

The system, process and image displays of FIGS. 1-8 are not exclusive. Other systems, processes and displays may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. An adaptive user interface system according to invention principles is applicable to user interfaces employing a markup language in any field and may be used with a web browser, for example. Further, any of the functions and steps provided in FIGS. 1-8 may be implemented in hardware, software or a combination of both and may reside on one or more processing devices located at any location of a network linking the FIG. 1 elements or another linked network including another intra-net or the Internet.

What is claimed is:

1. A user interface system for adaptively presenting information to a user, comprising:
a display processor for initiating generation of data representing an image including,
an image element box comprising a text data presentation row automatically expandable into a plurality of text data presentation rows in response to user selection of said image element box; and
an executable procedure associated with said image element box for determining whether text in said plurality of text data presentation rows is at least one of, (a) delete only, (b) read-only and (c) readable and writable, said executable procedure being in a user interface compatible code language, execution of said executable procedure being initiated in response to user selection of said image element box.

2. A system according to claim 1, wherein
said user interface compatible code language is an Internet Browser compatible code language.
said image element box enables text data entry by a user.

3. A system according to claim 1, wherein
said user interface compatible code language is at least one of, (a) HTML, (b) SGML, (c) XML, and derivatives thereof.

4. A system according to claim 1, wherein
said image includes a user selectable button associated with said plurality of text data presentation rows for at least one of (a) initiating generation of a dialog window presenting more information concerning said text in said plurality of text data presentation rows and (b) selecting an item in said plurality of text data presentation rows.

5. A system according to claim 1, wherein
said image includes a user selectable button associated with said plurality of text data presentation rows for initiating a calculation used in providing data for display in said plurality of text data presentation rows.

6. A system according to claim 1, including
a command processor for initiating generation of data representing an update of said image to include an expanded image element box comprising a plurality of text data presentation rows in response to user selection of said image element box.

7. A system according to claim 6, wherein
said command processor initiates execution of said executable procedure associated with said image element box to determine whether text in said plurality of text data presentation rows is, delete only, read-only or readable and writable in said expanded image element box, in response to user selection of said image element box.

8. A system according to claim 1, including
an interface processor for receiving context information wherein
said executable procedure automatically populates said plurality of text data presentation rows with data associated with said context information.

9. A system according to claim X, wherein
said context information comprises at least one of, (a) user identifier, (b) a patient identifier, (c) an application specific data object identifier and (d) information associated with a data field in a form including said image element box.

10. A system according to claim 1, including
said display processor initiates generation of a display window presenting data representing content of said image element box upon detection of a mouse-over.

11. A system according to claim 1, wherein
said executable procedure associated with said image element box automatically populates said plurality of text data presentation rows with at least one of, (a) data acquired from a separate dialog and (b) data derived in response to a calculation.

12. A system according to claim 11, wherein
said dialog comprises a dialog display enabling user data entry.

13. A system according to claim 1, wherein
said display processor initiates generation of data representing an image including a dialog including text associated with said text data presentation rows.

14. A system according to claim 135 wherein
said text in said dialog menu associated with said text data presentation rows indicates related data is at least one of, (a) an identifier of a user that entered text in said presentation rows and (b) a time and date of entry of text in said presentation rows.

15. A user interface system for adaptively presenting information to a users comprising:
a display processor for initiating generation of data representing an image window including,
an image element box comprising a text data presentation row automatically expandable into a plurality of text data presentation rows in response to user selection of said image element box; and
an executable procedure associated with said image element box for automatically populating said plurality of text data presentation rows and for determining said plurality of text data presentation rows are at least one of, (a) read-only and (b) readable and writable, said executable procedure being in a Internet Browser compatible code languages execution of said executable procedure being initiated in response to user selection of said image element box.

16. A system according to claim 15, wherein
said executable procedure associated with said image element box automatically populates said plurality of text data presentation rows with data acquired from a dialog.

17. A system according to claim 16, wherein
said dialog enables user data entry within an interactive user interface.

18. A system according to claim 15, including
an interface processor for receiving context information wherein
said executable procedure automatically populates said plurality of text data presentation rows with data associated with said context information.

19. A system according to claim 15, wherein
said executable procedure associated with said image element box automatically populates said plurality of text data presentation rows with data derived from a calculation.

20. A system according to claim 15, including
a configuration processor enabling user configuration of said image element box and determination said text data presentation rows are at least one of, (a) read-only, (b) readable and writable and (c) delete only.

21. A system according to claim 15, including
a configuration processor enabling user configuration of said image element box and determination of a style of presentation of text.

22. A user interface system for adaptively presenting information to a user, comprising:
a display processor for initiating generation of data representing an image window including
an image element box comprising a text data presentation row automatically expandable into a plurality of text data presentation rows in response to user selection of said image element box; and
an executable procedure associated with said image element box for automatically populating said plurality of text data presentation rows with data derived from a calculation and for determining said plurality of text data presentation rows are at least one of, (a) read-only and (b) readable and writable, said executable procedure being in a user interface compatible code language, execution of said executable procedure being initiated in response to user selection of said image element box.
